(19) United States
(12) Patent Application Publication
(10) Pub. No.: US 2004/0081597 A1
(43) Pub. Date: Apr. 29, 2004

(54) Method for charging a film to provide enhanced charge retention

(76) Inventor: James Smith, Corrales, NM (US)

Correspondence Address: The Law Offices of Calvin B. Ward, Suite 305, 18 Crow Canyon Court, San Ramon, CA, 94583, US

(21) Appl. No.: 10/281,049

(22) Filed: Oct. 24, 2002

(51) Int. Cl. B01J 19/08

(52) U.S. Cl. 422/186.04; 422/186.05

(57) ABSTRACT

An apparatus for charging a web. The apparatus includes a first charging station and a humidity controller. The first charging station includes a first pair of charging electrodes for applying an electric field across the web in a predetermined direction. The first pair of charging electrodes is located in a gaseous environment. The humidity controller maintains the relative humidity of the gaseous environment at between 20 and 50 percent. The first pair of charging electrodes includes a first electrode and a second electrode, the web passing between the first and second electrodes. The web is separated from the first electrode by a first gap filled with the gaseous environment. In the preferred embodiment of the present invention, the first electrode includes a plurality of protrusions, maintained at a DC potential relative to the second electrode. The DC potential is sufficient to ionize the gaseous environment.

### FIELD OF THE INVENTION

This invention relates generally to polymer-based electret films. More particularly, to the generation of electret films adapted for printing and having improved charge retention.

### BACKGROUND OF THE INVENTION

Electrically charged sheets, i.e., electrets, are particularly attractive as a medium for printing posters and the like. These sheets stick to vertical surfaces via an electrostatic attraction, and hence, the sheets may be affixed to walls, windows, and the like without the use of fasteners or adhesives.

Electret sheets have an insufficient charge lifetime for many applications. For the purposes of this discussion, the lifetime of an electret is defined to be the period of time over which the sheet will adhere to a surface before falling off. For many applications, lifetimes in excess of several months are needed. Currently available electrets do not provide such long lifetimes.

In prior art methods for generating an electret, a plastic sheet is charged by passing the sheet through an electric field that is generated by maintaining a constant voltage between two electrodes on opposite sides of the sheet. One of the electrodes is typically a roller over which the sheet passes while the other electrode is a charging bar suspended over the roller with an air gap between the charging bar and the sheet.

The amount of surface charge generated on the film in these arrangements depends on the strength of the electric field. Unfortunately, there is a limit to the electric field strength. As the voltage between the electrodes is increased, a point will be reached at which an arc is formed. Imperfections in the film such as pinholes exasperate the arcing problem because the insulation barrier provided by the film is reduced in the region of a pinhole. Arcs that start at pinholes can continue for some time because of the breakdown of the air over the film caused by an arc that passes between the electrodes through the pinhole. Such arcs damage the film in a manner that makes it unsuitable for high quality printing.

The charge imparted to the sheet can be viewed as consisting of two components, referred to as the hard charge and the soft charge. The soft charge dissipates relatively quickly and can be removed by subjecting the surface of the electret to water. The soft charge is of limited value in providing adhesion, since the charge usually dissipates during the printing of the poster or shortly after the poster is affixed to a surface in a high humidity environment. The hard charge, on the other hand, persists over a significant period of time, and hence, the hard charge determines the useful lifetime of the poster. Accordingly, it would be advantageous to provide a charging system that maximizes the hard charge.

Broadly, it is the object of the present invention to provide an improved apparatus and method for charging polymer films to be used in printing.

This and other objects of the present invention will become apparent to those skilled in the art from the following detailed description of the invention and the accompanying drawings.

### SUMMARY OF THE INVENTION

The present invention is an apparatus for charging a web. The apparatus includes a first charging station and a humidity controller. The first charging station includes a first pair of charging electrodes for applying an electric field across the web in a predetermined direction. The first pair of charging electrodes is located in a gaseous environment. The humidity controller maintains the relative humidity of the gaseous environment at between 20 and 50 percent. The first pair of charging electrodes includes a first electrode and a second electrode, the web passing between the first and second electrodes. The web is separated from the first electrode by a first gap filled with the gaseous environment. In the preferred embodiment of the present invention, the first electrode includes a plurality of protrusions, maintained at a DC potential relative to the second electrode. The DC potential is sufficient to ionize the gaseous environment. Embodiments in which the apparatus includes a second charging station can also be constructed. The second charging station includes a second pair of charging electrodes for applying an electric field across the web in the predetermined direction, the pair of charging electrodes being located in a gaseous environment that is maintained at a relative humidity of between 20 and 50 percent. The second pair of charging electrodes preferably includes a third electrode and a fourth electrode, the web passing between the third and fourth electrodes and being separated from the third electrode by a second gap filled with the gaseous environment. The third electrode includes a plurality of protrusions, maintained at a DC potential relative to the fourth electrode sufficient to ionize the gaseous environment. The first and second gaps are on opposite sides of the web. Embodiments that include a corona treatment station for corona treating at least one surface of the web prior to the web entering the first charging station may also be constructed. The corona treatment station includes a gaseous atmosphere that is maintained at a relative humidity of between 20 and 50 percent.

### BRIEF DESCRIPTION OF THE DRAWINGS

FIG. 1 is a cross-sectional view of a charging apparatus 10 according to the present invention for charging a web.

FIG. 2 is a side view of roller 43 and bar 41.

### DETAILED DESCRIPTION OF THE PREFERRED EMBODIMENTS OF THE INVENTION

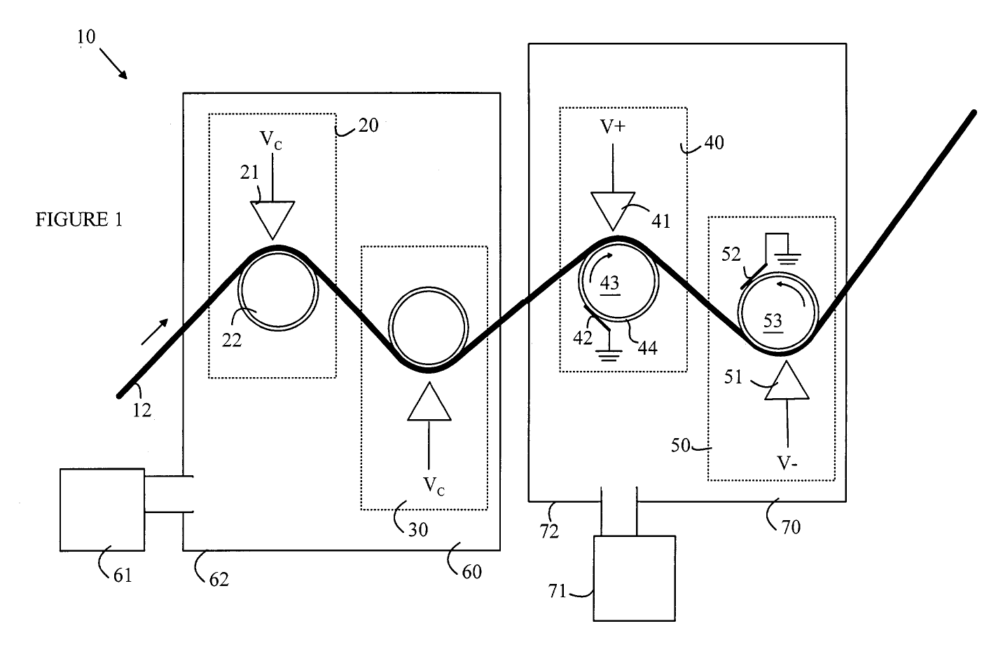

The present invention is based on the observation that the amount of hard charge imparted to a plastic film depends on the humidity of the air around the charging electrode and on the state of oxidation of the film surface. Refer now to FIG. 1, which is a cross-sectional view of a charging apparatus 10 according to the present invention for charging a web. Apparatus 10 surface treats and charges a web or film 12, which is preferably a biaxially-oriented polypropylene film having a thickness of 1 to 10 mils.

Charging apparatus 10 may be viewed as having two processing stations shown at 60 and 70. At processing station 60, the film is surface treated on each side using a corona discharge. Corona treating station 20 treats the top surface of the film. Station 20 preferably includes a metal roller 22 that is held at ground. An AC voltage is applied to an electrode 21, which produces a corona discharge. The ions produced by the discharge oxidize the film and create a site that will hold the charge that is subsequently applied to the film. The corona discharge is generated by applying an AC voltage between electrode 21 and roller 22 at a frequency of 17 kHz. The applied voltage is typically 150 V.

A second corona treating station 30 applies a similar treatment to the other side of the film. In embodiments of the present invention in which the film is only to receive ink on one side thereof, the second corona station may be eliminated; however, the degree of hard charge that is imparted to the film at the charging station discussed below will be less. It has been found experimentally that the relative humidity within the corona treatment station must be controlled to provide optimal charging of the web at processing station 70 discussed below. In the preferred embodiment of the present invention, enclosure 62 is maintained at a relative humidity of between 25 and 45 percent, and preferably between 30 and 40 percent, by humidity controller 61.

The treated film is then charged at processing station 70, which includes charging stations 40 and 50. Charging station 40 includes a roller 43 whose surface is held at ground. The surface of the roller can be constructed of a conductor and connected directly to ground or an insulating sleeve 44 can be provided as taught in U.S. Pat. No. 6,143,255, which is hereby incorporated by reference. An electrode 41 is held at a positive potential relative to the roller assembly. Any surface charge that accumulates on the surface of the insulating sleeve is removed by a conducting brush 42. This arrangement prevents a sustained arc from being generated between electrode 41 and roller 43. If an arc starts to form, charge accumulates on the insulating sleeve and quenches the arc. The accumulated charge is then removed by brush 42. Electrode 41 is preferably maintained at a potential of 25 to 30 KV above ground.

After film 12 leaves charging station 40, film 12 enters charging station 50 that is similar in design to charging station 40. Film 12 passes over a roller 53 having a surface that is maintained at ground by a brush 52. An electrode 51 connected to a negative power supply is positioned under film 12. Charging station 50 applies charge to the bottom surface of film 12 having the opposite polarity to the charge applied to the top surface of film 12 by charging station 40. Electrode 51 is preferably maintained at a potential between −13 and −20 KV.

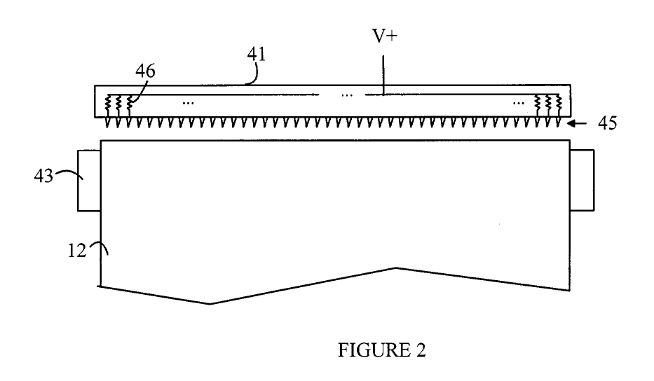

Refer now to FIG. 2, which is a side view of roller 43 and bar 41. Electrode 41 is preferably a bar that runs parallel to the axis of roller 43. The bottom surface of the bar 41 has regularly spaced points 45. Each point is connected to the power supply by a high voltage resistor 46, which limits the current that can flow through that point. The potential between electrode 41 and roller 43 is sufficient to ionize components of the gaseous atmosphere between the electrodes.

It is been found experimentally that the relative humidity within the film charging station 70 must be controlled to provide optimal charging of the web. In the preferred embodiment of the present invention, enclosure 72 is maintained at a relative humidity of between 20 and 50 percent by humidity controller 71. If the relative humidity is either greater than 50 percent or less than 20 percent, the amount of hard charge that is imparted to film 12 is greatly reduced.

The above-described embodiments of the present invention utilize separate humidity control chambers for the corona treatment and film charging processing stations. However, it should be noted that the two processing stations can be placed in a common chamber, since the optimum humidity ranges for the two processing stations are approximately the same.

Various modifications to the present invention will become apparent to those skilled in the art from the foregoing description and accompanying drawings. Accordingly, the present invention is to be limited solely by the scope of the following claims.

What is claimed is:

1. An apparatus for charging a web, said apparatus comprising:
a first charging station comprising a first pair of charging electrodes for applying an electric field across said web in a predetermined direction, said first pair of charging electrodes being located in a gaseous environment; and
a humidity controller for maintaining the relative humidity of said gaseous environment between 20 and 50 percent.

2. The apparatus of claim 1 wherein said first pair of charging electrodes comprises a first electrode and a second electrode, said web passing between said first and second electrodes and being separated from said first electrode by a first gap filled with said gaseous environment, said first electrode comprising a plurality of protrusions, said protrusions being maintained at a DC potential relative to said second electrode sufficient to ionize said gaseous environment.

3. The apparatus of claim 1 further comprising a second charging station comprising a second pair of charging electrodes for applying an electric field across said web in said predetermined direction, said pair of charging electrodes being located in a gaseous environment, said gaseous environment being maintained at a relative humidity of between 20 and 50 percent.

4. The apparatus of claim 3 wherein said second pair of charging electrodes comprises a third electrode and a fourth electrode, said web passing between said third and fourth electrodes and being separated from said third electrode by a second gap filled with said gaseous environment, said third electrode comprising a plurality of protrusions, said protrusions being maintained at a DC potential relative to said fourth electrode sufficient to ionize said gaseous environment, wherein said first and second gaps are on opposite sides of said web.

5. The apparatus of claim 4 wherein said second and fourth electrodes are held at the same potential.

6. The apparatus of claim 1 further comprising a corona treatment station for corona treating at least one surface of said web prior to said web entering said first charging station, said corona treatment station comprising a gaseous atmosphere that is maintained at a relative humidity of between 20 and 50 percent.

7. The apparatus of claim 6 wherein said relative humidity is maintained between 30 and 40 percent.
